(19) United States
(12) Patent Application Publication
(10) Pub. No.: US 2013/0008089 A1
(43) Pub. Date: Jan. 10, 2013

(54) SLIDING PANEL SYSTEMS

(76) Inventor: Elias Frankley MANCEBO, Barrie (CA)

(21) Appl. No.: 13/369,150

(22) Filed: Feb. 8, 2012

Related U.S. Application Data
(60) Provisional application No. 61/440,681, filed on Feb. 8, 2011.

(30) Foreign Application Priority Data
Jun. 30, 2011 (CA) 2745122

(51) Int. Cl. E05D 15/08

(52) U.S. Cl. 49/413

(57) ABSTRACT

A sliding panel system includes a door sill, an inner panel support, an inner sliding track, an outer panel support, and inner panel and an outer panel. The door sill has a left hand side and a right hand side. The inner panel support is connected to the door sill. The inner sliding track is connected to the inner panel support. The outer panel support is connectable to the door sill whereby the outer panel support is connectable to one of the left hand side and the right hand side of the door sill. The inner panel is slidingly supported on the inner sliding track and the outer panel supported on the outer panel support.

### CROSS REFERENCE TO RELATED PATENT APPLICATION

This patent application relates to U.S. Provisional Patent Application Ser. No. 61/440,681 filed on Feb. 8, 2011 entitled IMPROVED SLIDING PANELS and Canadian Patent Application 2,745,122, filed Jun. 30, 2011 entitled IMPROVED SLIDEING PANEL SYSTEMS, both of which are incorporated herein by reference in its entirety.

### FIELD OF THE INVENTION

This invention relates to sliding panel systems and in particular modular panel support systems that can be configured in a plurality of different ways.

### BACKGROUND OF THE INVENTION

Currently the panel supports systems that are generally available have only one configuration. Specifically the panel support systems are configured such that both panels are sliding panels or one panel is fixed and the other panel is sliding. Further, when the configuration is a fixed panel and a sliding panel either the left is fixed or the right is fixed. Accordingly, if a retailer wants to have all configurations available it needs to keep each configuration in stock. This ties up both a lot of capital as well as a lot of space. Typically the panels are either a door or a window.

As well, a draw back with many of the prefabricated panel support systems currently on the market is that the frame for each system is a predetermined size. This is problematic since not all structures have the same wall thickness. Accordingly, if a retailer wants to keep in stock panel systems that can be used with different wall thicknesses they need to tie up a lot of capital as well as a lot of space.

Accordingly it would be advantageous to provide a panel support system that has multiple configurations. As well it would be advantageous to provide a panel support system that can be used with different wall thicknesses.

### SUMMARY OF THE INVENTION

The door sill has a left hand side and a right hand side. The inner panel support is connected to the door sill. The inner sliding track is connected to the inner panel support. The outer panel support is connectable to the door sill whereby the outer panel support is connectable to one of the left hand side and the right hand side of the door sill. The inner panel is slidingly supported on the inner sliding track and the outer panel supported on the outer panel support.

The door sill and the inner panel support may be integrally formed.

The sliding panel system may further include a XX outer panel support and an outer sliding track connectable to the outer panel support and the XX outer panel support, whereby the outer panel is an outer sliding panel.

The sliding panel system may further include a shim between the inner panel support and the outer panel support.

The XX outer panel support may include an interior leg, and exterior leg and a middle leg and the middle leg snaps into the sill. The outer panel support may include an interior leg, and exterior leg and a middle leg and the middle leg snaps into the sill.

The door sill may include a front portion and an extension cap attachable to the front portion. The extension cap may be a snap in extension cap. The sliding panel system may further include a wood buck and wherein the sill is adapted to receive the wood buck.

The sliding panel system may further include a nose attachable to door sill. The nose may include a screen support and further including a screen slidingly supported on the screen support.

The sliding panel system may be one of a sliding door system and a sliding window system.

In another embodiment a sliding panel system includes a door sill, an inner panel support, an inner sliding track, an outer panel support, and inner panel and an outer panel. The door sill has a front portion and an extension cap and a left hand side and right hand side. The inner panel support is connected to the door sill. The inner sliding track is connected to the inner panel support. The outer panel support is connected to the door sill whereby the outer panel support is connected to one of the left hand side and the right hand side of the door sill. The inner panel is slidingly supported on the inner sliding track. The outer panel is supported on the outer panel support.

The extension cap may snap into the front portion of the sill.

The extension cap may be a plurality of extension caps wherein each extension cap of the door sill is dimensioned to fit different dimensioned door jam. Alternatively, the extension cap is dimensioned to fit a predetermined door jam dimension.

The sliding panel system further includes a wood buck and the sill is adapted to receive the wood buck.

The sliding panel system may further include a nose attachable to door sill. The nose may include a screen support and further including a screen slidingly supported on the screen support.

The outer panel support may be connected to the left hand side and the right hand side and further including an outer sliding track and wherein the outer panel is an outer sliding panel.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of an embodiment of the sliding panel system constructed in accordance with the present invention showing the configuration wherein one of the panels is stationary;

FIG. 2 is an enlarged perspective view or a portion of the sliding panel system of the FIG. 1 showing the outer panel support;

FIG. 3 is a perspective view of the outer panel support;

FIG. 4 is a sectional view of the sliding panel support system shown in FIG. 1;

FIG. 5 is an enlarged sectional view of a portion of the sliding panel support system of FIG. 4 showing the outer panel support;

FIG. 6 is a sectional view similar to that shown in FIG. 4 but showing the configuration wherein the outer panel is a sliding panel;

FIG. 7 is an enlarged sectional view of a portion of the sliding panel support system of FIG. 5 showing the outer panel support;

FIG. 8 is a perspective view of an embodiment of the sliding panel system constructed in accordance with the present invention showing the configuration wherein the inner panel and the outer panel are both sliding panels;

FIG. 9 is an enlarged perspective view of a portion of the sliding panel support system of FIG. 8 showing the outer panel support with a sliding track;

FIG. 10 is a perspective view showing the elements that are added to convert the sliding panel system from a stationary panel to a sliding panel;

FIG. 11 is an enlarged perspective view of the sliding panel system shown in FIG. 10 but showing the outer panel support configured for a sliding panel;

FIG. 12 is a perspective view of an embodiment of a XX outer panel support for use with the panel support and a sliding track;

FIG. 13 is a sectional view similar to that shown in FIG. 4 but also including a wood buck;

FIG. 14 is a sectional view similar to that shown in FIG. 6 but also showing a wood buck;

FIG. 15 is a blown apart perspective view of an alternate sill having an outer sill and an inner sill and showing alternate attachable inner sills;

FIG. 16 is a sectional view of the smaller alternate sill of FIG. 15 and shown with a wood buck;

FIG. 17 is an enlarged sectional view of sill of FIG. 16 and showing the connection of the inner sill to the outer sill;

FIG. 18 is a sectional view of the larger alternate sill of FIG. 15 and shown with a wood buck; and

FIG. 19 is an enlarged sectional view of sill of FIG. 18 and showing the connection of the inner sill to the outer sill.

### DETAILED DESCRIPTION OF THE INVENTION

The sliding door system of the present invention may include a sliding doors (an X door) and a stationary door (an 0 door) or a combination thereof. According the sliding door system of the present invention may be an OX wherein the stationary door is on the left and the sliding door is on the right, an XO where the stationary door is on the right and the sliding door is on the left or an XX door system where both doors slide. As well it may include system with more than two doors. The system is modular and thus there may be a wide variety of door configurations.

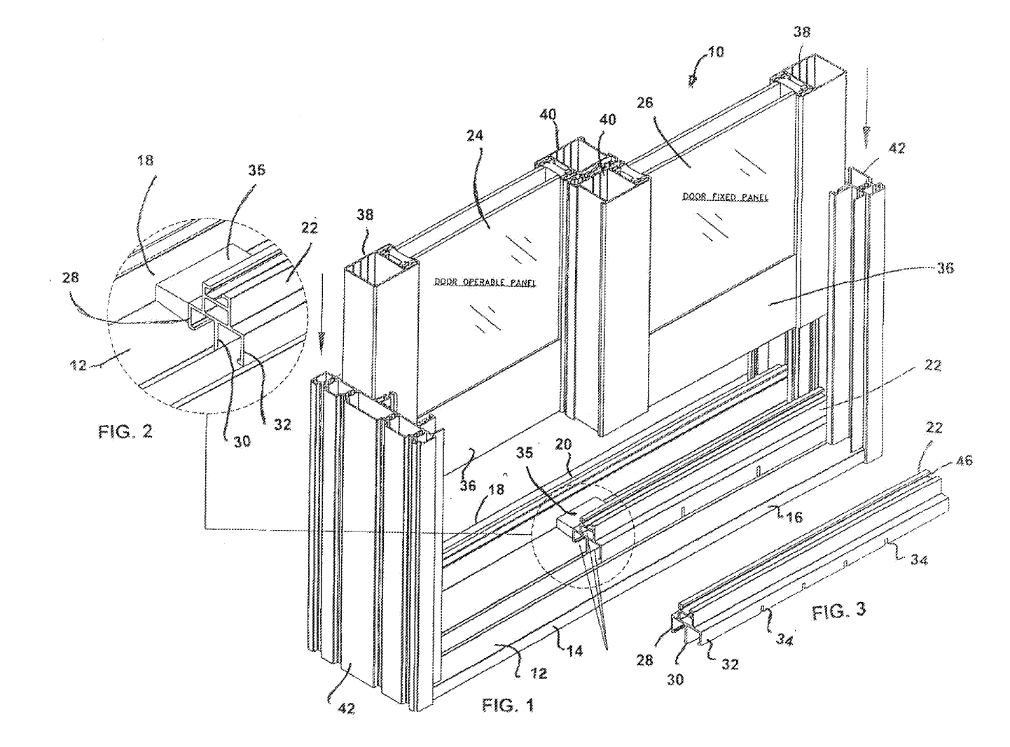

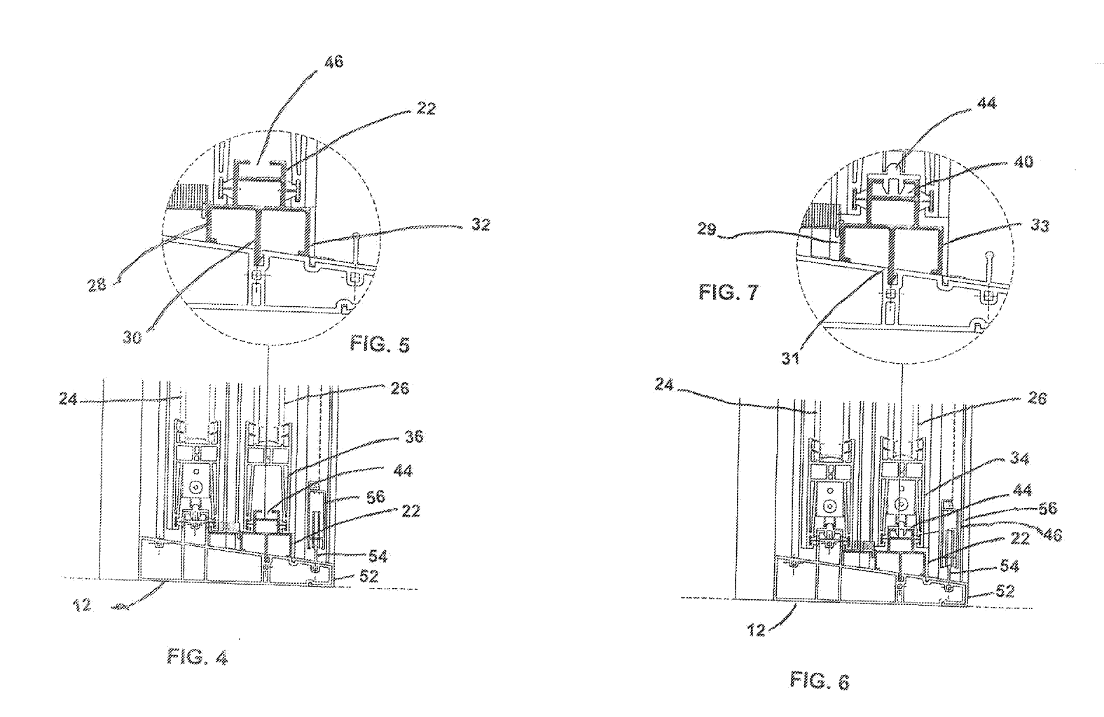

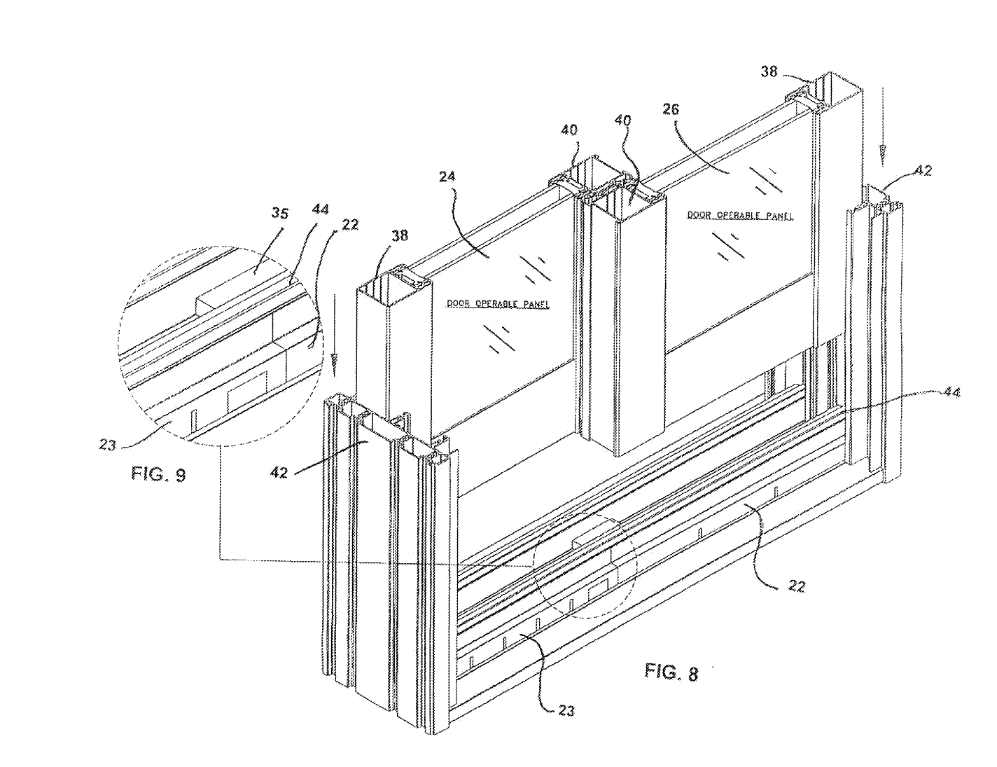

Referring to FIG. 1, the sliding panel system configured for an XO or OX arrangement is shown generally 10. The details of this configuration are shown in FIGS. 2 to 5.

The sliding panel system 10 includes a door sill 12 with a left hand side 14 and a right hand side 16. An inner panel support 18 is connected to the door sill 12. An inner sliding track 20 connected to the inner panel support 18. An outer panel support 22 is connectable to the door sill 12 whereby the outer panel support is connectable to one of the left hand side 14 or the right hand side 16 of the door sill. If it is connected to the left hand side 14 a XO arrangement is configured and if it is connected to the right hand side 16 an OX arrangement is configured. An inner panel 24 is slidingly supported on the inner sliding track 20. An outer panel 26 is supported on the outer panel support 22.

The outer panel support 22 has three legs, interior 28, center 30 and exterior 32. The center leg 30 is a snap in place leg. The center leg 30 provides for a differential between the exterior and interior air pressure. The outer panel support 22 has multiple drainage holes 34 formed therein. The drainage holes in the three legs are not aligned thereby providing a circuitous path for the air to go from the inside of the building to the outside of the building. As the result a higher pressure differential is required to push the air from exterior to interior than would be required if the holes where aligned. This provides better performance for the door than there would be if the holes were aligned. A shim or water retainer 35 is positioned between the outer panel support 22 and the inner panel support 18.

The outer panel 26 is positioned over the outer panel support 22 is which in this configuration is stationary and which is on only half of the door. The end of the outer panel support 22 is closed with a slide-in cover (not shown) which is attachable to the interlocking stile 40 of outer panel 26. The slide-in cover is designed to prevent water penetration while allowing air filtration on the XO and OX configuration only. The drainage holes 34 are two small ones in the front and four in the back located inside the house. By doing this, water drains out faster and is unlikely to return back into the house.

The inner panel 24 and outer panel 26 each have bottom rail or sash 36 and a top rail or sash (not shown). On the sides the inner panel 24 and outer panel 26 each have stiles on either side thereof. In the configuration shown in FIG. 1 the inner panel 24 and outer panel 26 each have an outer stile 38 and an interlocking stile 40. The outer stile 38 is adapted to engage the door jamb 42 and the interlocking stiles 40 are adapted to engage each other. Referring to FIGS. 6 to 9 the XX configuration is shown wherein both the inside panel 24 and the outside panel 26 are movable. In the XX configuration there are the outer panel support 22 and XX panel support 23 are attached to the sill 12 such that an outer panel support extends from one jamb 42 to the other. A slider track 44 is attached to the out panel supports 22 and extends from one jamb 42 to the other. Preferably the slider track 44 is made from aluminum.

In the XX panel support 23 the exterior drainage is separated from the interior drainage on the XX added panel support with the snap in center legs 31, by having these center legs there is a differential between the exterior and interior air pressure. The XX panel support 23 has an interior leg 29, a center leg 31 and an exterior leg 33. The XX panel support 23 has drainage holes 34 as well as extra large drainage holes 35. In addition there are drainage or weeping holes from front to back. In the embodiment shown herein, on the outside face of the panel support there are two large weeping holes and seven small ones. These weeping holes provide for faster water relief this is particularly important in the XX configuration.

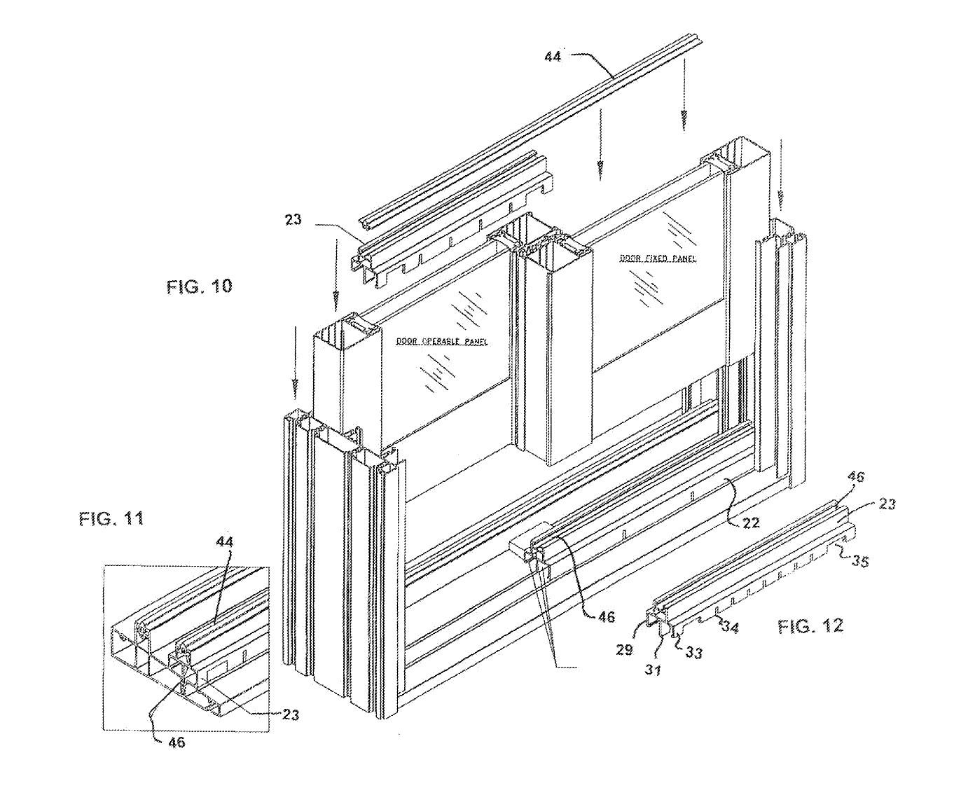

FIG. 10 shows the transition from an OX configuration to an XX configuration. The outer panel support 22 is on the half of the door. The XX outer panel support 23 is snapped in place adjacent to the outer panel support 22 and thus a panel support extends from one door jamb 42 to the other. Thereafter a track 44 is snapped into channel 46 formed in both outer panel support 22 and xx outer panel support 23.

Multi use snap in and removable outer panel support 22 is used for XO and OX door configuration, as well as XX door configuration. XX outer panel support 23 is used for XX configuration together with snap in aluminum slider track 44 for XX door configuration only.

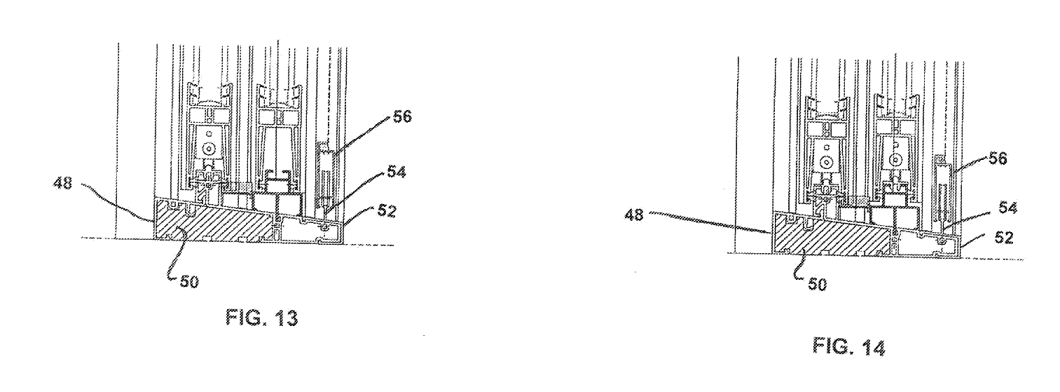

Referring to FIGS. 13 and 14 the sill 48 may be adapted to include a wood buck 50. Sills 12 and 48 may each have nose 52 snapped thereto. Nose 52 includes a screen support 54. Screen 56 slides on screen support 54.

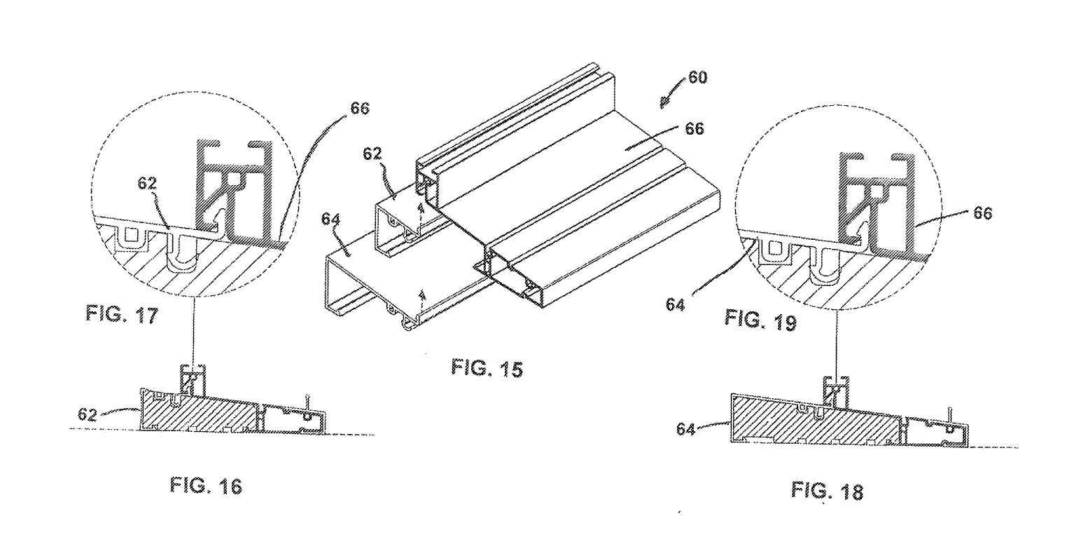

Referring to FIGS. 15 to 19, sill 60 may also be an adjustable split wood buck sill. Adjustable split wood buck sill 60 may come in a kit with multiple sizes of extension caps 62, 64 to accommodate different sizes of door jams without using wood or PVC jamb extensions. The multiple sizes of extension caps 62, 64 correspond to different door jams such that the door sill is dimensioned to fit different dimensioned door jam. The user can then choose the particular size of extension cap 62, 64 that fits. Alternatively the adjustable split wood buck sill may be sold such that the user or purchaser chooses between alternative extension caps 62, 64 so as to choose an extension cap that fits a predetermined door jam dimension. Accordingly an extension cap 62 or 64 is chosen to fit the width of the door jam in the particular location wherein the sill is being installed. Split sill 60 includes a front portion 66 and an extension cap 62 or 64. Extension caps 62, 64 are designed to snap into front portion 66.

The sliding panel system 10 has a number of features. Specifically the outer panel support 22 is convertible into a slider track. The system 10 includes a Universal H-mullion design. As described above the system may include a multi-chamber wood-bucked frame design with variable jamb width. In addition, the system may include full perimeter triple weather stripping with plastic fins. The system 10 is designed to have mechanically-fasten panels and metal-reinforced panels. The system has a removable fixed panel support such that the panel that is fixed may be either on the left hand side or the right hand side. Preferably the system includes anodized aluminium tracks. The sill 12 is sloped. The sliding panels include zinc-plated double tandem wheels with sealed bearing. The system 10 may include a premium heavy-gauge extruded aluminium screen with surface mounted lock (not shown). The system may include a 1″ thick I.G. unit with white warm edge

The sliding panel system 10 allows for a wide variety of configurations including OX, XO and XX when a two panel system. However it will be appreciated by those skilled in the art that the sliding panel system may be expanded to include three or more panels. Specifically the system 10 is fully reversible for both left- and right-hand operation. Accordingly, the sliding panel system 10 allows for a vast variety of aesthetically pleasing multi-panel combinations. Extra chambers in the header, jamb and sill profile components create thermal and moisture barriers from the elements. Such design will offer longer service life-cycle of the wood core, especially in the sill, due to extra protection against wood rot and decay.

Preferably screen 56 is a heavy duty screen is built with thick, extruded aluminium frame, and offers smooth sliding system.

The dual panel supports with snap in aluminium tracks allows for double sliding doors for versatility and easy removal of door panels. The universal H-bar design allows for the reversibility of patio door system and “dual-handed” configuration. The panel system shown herein allows for a vast variety of aesthetically pleasing multi-panel combinations. Additional triple seal weather stripping may be included for extra air-tightness between panels.

The all-vinyl multi-chamber profile design, shown in FIGS. 1 to 12, has good insulating characteristics for comfort and energy saving. The full perimeter triple weather stripping helps reduce and in most cases eliminates water and air infiltration between frame and panels. Mechanically fastened panels with metal reinforcement provide dimensional stability for years of smooth and stable operations.

The panel supports 22 and 23 are removable and thus can be repaired without removing the frame.

Preferably the tracks 44 are anodized aluminium and the wheels are double tandem wheels with sealed bearings. Together these provide a durability and corrosion resistance for many years of smooth and easy operation.

Preferably the screen 56 has a heavy duty aluminium frame and a self-cleaning, anodized aluminium track thus providing a smooth sliding system.

The wood buck embodiments shown in FIGS. 13 to 19 have most of the same advantages as those of the all vinyl version. They also has some additional advantages. Specifically the multi-chamber wood-bucked frame which includes a header and jamb is designed to create extra chambers in the header, jamb and sill. These extra chambers help create an enhanced thermal profiles and moisture barriers to the outdoor environment. These enhanced insulating characteristics provide comfort and energy saving. Longer service life-cycle due to extra protection against wood decay.

The wood buck version of the panel support system allows for variable jamb widths. Specifically, the frame profiles (jamb, header and sill components) are designed to allow flexibility in width by extending the width of the wood-core. The system is flexible to allow application to houses with varying wall thickness (as to accommodate different climate conditions). The system will allow easy insertion of wood-core into the vinyl cladding and will also allow such insertion be delayed until later in the fabrication/installation process.

Preferably the panels have metal reinforcement thereby providing for dimensional stability for years of smooth and stable operations.

It will be appreciated by those skilled in the art that the various elements of the embodiments of the present invention may be made from various materials. For example the glass in the panels 24, 26 may be standard glass; low emissivity with argon glass; tinted or bronzed glass; V-grooved glass with a various standard or special order designs; decorative grill with the glass; or blinds with the glass. The panel support system may be produced in stock colours or custom colours. The hardware includes a handle set and nylon rollers.

The panel system has a number of security features. Specifically it includes a kick lock, a guard lock, a multipoint lock, a key lock and a security bar.

There are a number of advantages realized by the panel system disclosed herein. Specifically the panel supports on the header jamb and sill are designed to accommodate tracks so that two door panels can slide. Existing sliding doors only allow single slider feature.

The panel supports are also removable for easy repair. This feature is especially important in the new construction application where these panel supports are susceptible to damage due to heavy traffic during construction. Without this feature, the whole frame must be removed in order to repair the damage.

Unlike existing mullions, our mullion profile was designed as to allow aesthetically pleasing multi-panel system. In addition, it creates reversibility of the patio door system, thus, creates “non-handed” configuration. Finally, the symmetrical mullion design also allows triple-seal weather stripping for air-tightness as the result of incorporating two weather seals and one bulb seal in the mullion profile.

The wood buck embodiment also has a number of advantages. Specifically, the additional chamber in the frame/jamb and sill profiles creates thermal- and moisture-barriers to the outdoor environment. The moisture barrier is particularly important with the sill profile as moisture exposure is most severe at the bottom.

The jamb profiles (vertical and header) are designed to allow different jamb width by extending the width of the wood core. This will allow the door to be applied to houses with varying wall thickness (as to accommodate different climates).

The jamb profiles are so designed that the wood core can be easily inserted by snapping it in later in the fabrication of the system.

It will be appreciated by those skilled in the art that the sliding panel support system described herein would work with multiple panels. As well it would work with sliding doors as well as sliding windows. Further it will be appreciated by those skilled in the art that the sliding panel system may be one of a sliding door system and a sliding window system.

Generally speaking, the systems described herein are directed to a panel support system. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a panel support system.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed is:

1. A sliding panel system comprising:
a door sill having a left hand side and a right hand side;
an inner panel support connected to the door sill;
an inner sliding track connected to the inner panel support;
an outer panel support connectable to the door sill whereby the outer panel support is connectable to one of the left hand side and the right hand side of the door sill;
an inner panel slidingly supported on the inner sliding track; and
an outer panel supported on the outer panel support.

2. The sliding panel system of claim 1 wherein the door sill and the inner panel support are integrally formed.

3. The sliding panel system of claim 2 further including an XX outer panel support and an outer sliding track connectable to the outer panel support and the XX outer panel support and whereby the outer panel is an outer sliding panel.

4. The sliding panel system of claim 3 further including a shim between the inner panel support and the outer panel support.

5. The sliding panel system of claim 3 wherein the XX outer panel support includes an interior leg, an exterior leg and a middle leg and the middle leg snaps into the door sill.

6. The sliding panel system of claim 1 wherein the outer panel support includes an interior leg, an exterior leg and a middle leg and the middle leg snaps into the door sill.

7. The sliding panel system of claim 1, wherein the door sill includes a front portion and an extension cap attachable to the front portion.

8. The sliding panel system of claim 7 wherein the extension cap is a snap in extension cap.

9. The sliding panel system of claim 1 further including a wood buck and wherein the door sill is adapted to receive the wood buck.

10. The sliding panel system of claim 1 further including a nose attachable to door sill.

11. The sliding panel system of claim 10 wherein the nose includes a screen support and further including a screen slidingly supported on the screen support.

12. The sliding panel system of claim 1 wherein the sliding panel system is one of a sliding door system and a sliding window system.

13. A sliding panel system comprising:
a door sill having a front portion and an extension cap and a left hand side and right hand side;
an inner panel support connected to the door sill;
an inner sliding track connected to the inner panel support;
an outer panel support connected to the door sill whereby the outer panel support is connected to one of the left hand side and the right hand side of the door sill;
an inner panel slidingly supported on the inner sliding track; and
an outer panel supported on the outer panel support.

14. The sliding panel system of claim 13 wherein the extension cap snaps into the front portion of the door sill.

15. The sliding panel system of claim 13 wherein the extension cap is a plurality of extension caps wherein each extension cap of the door sill is dimensioned to fit different dimensioned door jam.

16. The sliding panel system of claim 13 wherein the extension cap is dimensioned to fit a predetermined door jam dimension.

17. The sliding panel system of claim 13 further including a wood buck and the door sill is adapted to receive the wood buck.

18. The sliding panel system of claim 13 further including a nose attachable to door sill.

19. The sliding panel system of claim 18 wherein the nose includes a screen support and further including a screen slidingly supported on the screen support.

20. The sliding panel system of claim 13 whereby the outer panel support is connected to the left hand side and the right hand side and further including an outer sliding track and wherein the outer panel is an outer sliding panel.

21. The sliding panel system of claim 13 wherein the sliding panel system is one of a sliding door system and a sliding window system.
